(19) United States
(12) Patent Application Publication
(10) Pub. No.: US 2018/0306454 A1
(43) Pub. Date: Oct. 25, 2018

(54) DESICCANT WHEEL DRYING DEVICES AND DRYING APPARATUS USING THEREOF

(71) Applicant: INDUSTRIAL TECHNOLOGY RESEARCH INSTITUTE, Hsinchu (TW)

(72) Inventors: Ming-Lang HUNG, Hsinchu (TW); Yu-Hao KANG, Hsinchu (TW); Chih-Hao CHEN, Hsinchu (TW); Jyi-Ching PERNG, Hsinchu (TW); Ching-Eenn TSAI, Hsinchu (TW); Hsing-Ting CHEN, Hsinchu (TW)

(73) Assignee: INDUSTRIAL TECHNOLOGY RESEARCH INSTITUTE, Hsinchu (TW)

(21) Appl. No.: 15/626,570

(22) Filed: Jun. 19, 2017

(30) Foreign Application Priority Data
Apr. 20, 2017 (TW) 106113260

(51) Int. Cl. F24F 3/14; B01D 53/26; B01D 53/06

(52) U.S. Cl. CPC F24F 3/1423; B01D 53/261; B01D 53/06; F24F 2203/1032; B01D 2253/106; B01D 2253/304; B01D 2253/108; B01D 2259/4009; B01D 53/266

(57) ABSTRACT

Disclosed is a drying device which includes desiccant wheels or desiccant wheels combined with adsorbent, and a drying apparatus using thereof. The desiccant wheel drying device includes a plurality of desiccant wheels made of direct heating desorption substrates. The drying apparatus using the drying device includes: two pressure tanks capable of performing adsorption dehumidification and regeneration desorption of moisture in compressed air. The two pressure tanks exchange functions in batches to achieve the moisture adsorption of the compressed air and the regeneration desorption of the adsorbent. When performing the air dehumidification and desorption regeneration, the structures of the air flow paths in the desiccant wheel drying device can obtain an equalized temperature rise control by a temperature compensation method using a preheater and the divisional temperature control method of the drying device, in order to achieve improvement in the regeneration performance and energy saving for the desiccant wheel drying device.

### BACKGROUND

### 1. Technical Field

The present disclosure relates to air dehumidification and desorption regeneration techniques, and, more particularly, to a drying device composed of desiccant wheels or a combination of desiccant wheels and adsorbent, and a drying apparatus using the same.

### 2. Description of Related Art

With the industrial processes tending towards increasing automation and precision, the requirements for air quality in the manufacturing sites and equipment have become more stringent. It is desirable to ensure the proper rate of the manufacturing processes, wherein the humidity of the compressed air is very important for a variety of processes, and humidity control has become one of the major research areas in which the manufacturers are focusing.

A conventional adsorption type compressed air drying device generally includes two adsorption towers for adsorption of the moisture in the compressed air. In general, the adsorption towers are filled with adsorbent capable of adsorption dehumidification and desorption regeneration, such as silica gel particles, a zeolite molecular sieve or activated charcoal etc. When compressed air containing a higher percentage of moisture enters into one of the adsorption towers through a pipeline, moisture adsorption dehumidification treatment is carried out, and dry compressed air after the treatment will be guided to a storage tank for use later on. At this time, the moisture adsorbed by the adsorbent inside the adsorption towers can be desorbed using thermal energy, usually through a heater. In other words, the thermal energy required for the desorption regeneration of the adsorbent in the adsorption towers is provided by the heater. During the desorption regeneration process, through a method such as radiation, convection, solid heat transfer or the like, hot air for desorption regeneration is heated up to a temperature that enables desorption of the moisture in the adsorbent and then guided into the adsorption towers, in which desorption regeneration of the adsorbent is performed. Thereafter, hot and humid compressed air is guided and exhausted out of the adsorption towers, completing the desorption regeneration treatment of the adsorbent, allowing the adsorbent to be reused for adsorption dehumidification again.

It is clear from the above that there will be heat transfer between the hot air used for desorption regeneration and the walls of the pipeline transferring the hot air, resulting in energy loss. In addition, during desorption regeneration, thermal energy is transmitted to the adsorbent by convection of hot air, there may be uneven heat distribution in the adsorption bed in that the inlet for the hot air is the hottest while the outlet is the coldest. Thus, the time for regeneration is inevitably lengthened. Moreover, during the heating process, excess low-temperature waste hot air has to be vented out first, thus resulting in the conventional adsorption compressed air drying device energy intensive.

Therefore, in view of the energy loss of various thermal energy desorption regeneration methods or the uneven distribution of regeneration temperature in the pipeline and energy loss of the direct heating desorption regeneration method described above, there is still room for improvement in the existing compressed air dehumidifying technology and equipment, in particular, the shortcoming of poor regeneration efficiency due to energy loss is addressed.

### SUMMARY

The present disclosure provides a drying device which includes desiccant wheels or desiccant wheels combined with an adsorbent, and a drying apparatus using two drying devices composed of the plurality of desiccant wheels or two drying devices each being a combination of the plurality of desiccant wheels and the adsorbent. The drying apparatus includes a plurality of desiccant wheels composed of direct heating desorption substrates, or a plurality of desiccant wheels composed of direct heating desorption substrates and an adsorbent. The two desiccant wheel drying devices further include two pressure tanks capable of performing adsorption dehumidification and regeneration desorption of moisture in compressed air. The two pressure tanks exchange functions in batches to achieve the moisture adsorption of the compressed air and the regeneration desorption of the adsorbent. When performing the dehumidification and desorption regeneration, the structures of the air flow paths in the desiccant wheel drying devices can obtain an equalized temperature rise control by a temperature compensation method using a preheater and the divisional temperature control method of the drying devices, in order to achieve improvement in the regeneration performance and energy saving for the desiccant wheel drying devices.

The desiccant wheel drying device with the plurality of desiccant wheels according to the present disclosure further includes a pressure tank for performing adsorption dehumidification and regeneration desorption of the moisture in the compressed air, wherein the pressure tank is used for receiving a plurality of direct heating desiccant wheels. An upper tank lid and a lower tank lid are joined to the top and the bottom of the pressure tank, respectively, to form a pressurized chamber.

The present disclosure further provides a drying device with a combination of a plurality of desiccant wheels and an adsorbent. The drying device further includes two pressure tanks for performing adsorption dehumidification and regeneration desorption of the moisture in the compressed air, wherein the pressure tank is used for receiving a plurality of direct heating desiccant wheels and a particle adsorbent basin. The particle adsorbent basin is provided on the top of the plurality of direct heating desiccant wheels, so that the particle adsorbent basin can use the excess heat generated from the direct heating desiccant wheels below for desorption regeneration. An upper tank lid and a lower tank lid are joined to the top and the bottom of the pressure tank, respectively, to form a pressurized chamber.

The present disclosure provides a drying apparatus, which includes a plurality of pressure drying tanks that exchange functions in batches through associated control valves and pipelines, achieving adsorption dehumidification and desorption regeneration of the pressure drying tanks.

The present disclosure further provides a dehumidification process for the drying apparatus. A dehumidification inlet pipeline is provided above each of the pressure tanks. By turning on a dehumidification inlet valve and turning off a dehumidification inlet valve, compressed air to be dehumidified is guided to the pressure tank for moisture adsorption drying treatment. The temperature of the adsorption materials in the pressure tank at this time may rise too high after the regeneration process. This would reduce the adsorption efficiency. A cooling device is needed to provide cool air to cool down the adsorption materials. Typically, the adsorption drying treatment is performed after the temperature is cooled below 50° C. Dehumidified compressed air is guided below the pressure tank to an appropriate place through a dehumidification exhaust pipeline by turning on a dehumidification exhaust valve and turning off a dehumidification exhaust valve.

The present disclosure provides a desorption regeneration process for a drying apparatus. A regeneration fan provides the drive for air circulation during desorption regeneration. A regeneration fan filter filters out dust or impurities in the air entering the fan. By turning on a regeneration inlet valve and turning off a regeneration inlet valve, the air for regeneration is guided through a regeneration inlet pipeline to the pressure tank. Meanwhile, the direct heating desiccant wheels in the pressure tank are heated by a programmable logic controller (PLC) in an electric control box to a specific temperature depending on the types of adsorbents. For example, 80-140° C. is for silica, and 100-170° C. is for zeolite (molecular sieve). The air after regeneration in the pressure tank is exhausted through a regeneration exhaust pipeline by turning on a regeneration exhaust valve and turning off a regeneration exhaust valve.

Compared to the prior art, the drying device having desiccant wheels only or a combination of desiccant wheels and an adsorbent proposed by the present disclosure not only increases the effective areas through which air flows, but also performs air dehumidification using desiccant wheels composed of direct heating desorption substrates. In particular, electrically controlled layered heating enables equalized temperature of the air passages of the desiccant wheels during the desorption regeneration process, thereby reducing energy consumption while improving the efficiency of the desorption regeneration process.

### BRIEF DESCRIPTION OF THE DRAWINGS

FIG. 1 is a schematic diagram illustrating a dehumidification substrate in the direct heating desiccant wheel in accordance with the present disclosure;

FIG. 2 is an exploded view illustrating the structure of the direct heating desiccant wheel in accordance with the present disclosure;

FIG. 3 is a schematic diagram illustrating the interior structure of a desiccant wheel drying device composed of a plurality of desiccant wheels connected in series in accordance with the present disclosure;

FIG. 4A is a schematic diagram illustrating the interior structure of a drying device composed of a plurality of desiccant wheels and an adsorbent in accordance with the present disclosure;

FIG. 4B is a schematic diagram illustrating the structure of a particle adsorbent basin in accordance with the present disclosure;

FIG. 5 is a schematic diagram illustrating the outer appearance of the desiccant wheel drying device in accordance with the present disclosure;

FIG. 6 is a schematic diagram illustrating the front appearance of the compressed air drying apparatus in accordance with the present disclosure;

FIG. 7 is a schematic diagram illustrating the back appearance of the compressed air drying apparatus in accordance with the present disclosure;

FIG. 8 is a power supply diagram for a compressed air drying apparatus containing direct heating desiccant wheels only in accordance with the present disclosure; and

FIG. 9 is a power supply diagram for a compressed air drying apparatus with hybrid adsorption components in accordance with the present disclosure.

### DETAILED DESCRIPTION

The present disclosure is described by the following specific embodiments. Those with ordinary skills in the arts can readily understand other advantages and functions of the present disclosure after reading the disclosure of this specification. The present disclosure may also be practiced or applied with other different implementations. Based on different contexts and applications, the various details in this specification can be modified and changed without departing from the spirit according to the present disclosure.

The present disclosure is to provide a drying device made of desiccant wheels or a combination of desiccant wheels and adsorbent, and a drying apparatus using the drying device. The desiccant wheels include direct heating desiccant wheels (such as those described in TW Patent Application No. 105113435), and the drying device can be made up from a plurality of direct heating desiccant wheels arranged in series, or a series combination of desiccant wheels and tanks containing adsorbent particles, forming a drying device capable of adsorbing moisture in the humid air. In operation, water adsorbed in the direct heating desiccant wheels and the adsorbent particles can be desorbed by thermal regeneration, allowing them to be reused for dehumidification again. A compressed air drying apparatus with direct heating desiccant wheels only and a compressed air drying apparatus with hybrid components can be controlled by a logic control circuit in order to achieve adsorption dehumidification of the air and desorption regeneration of the adsorbent.

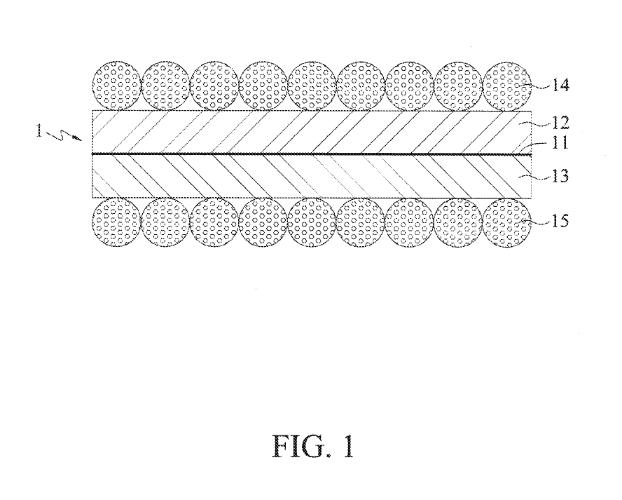

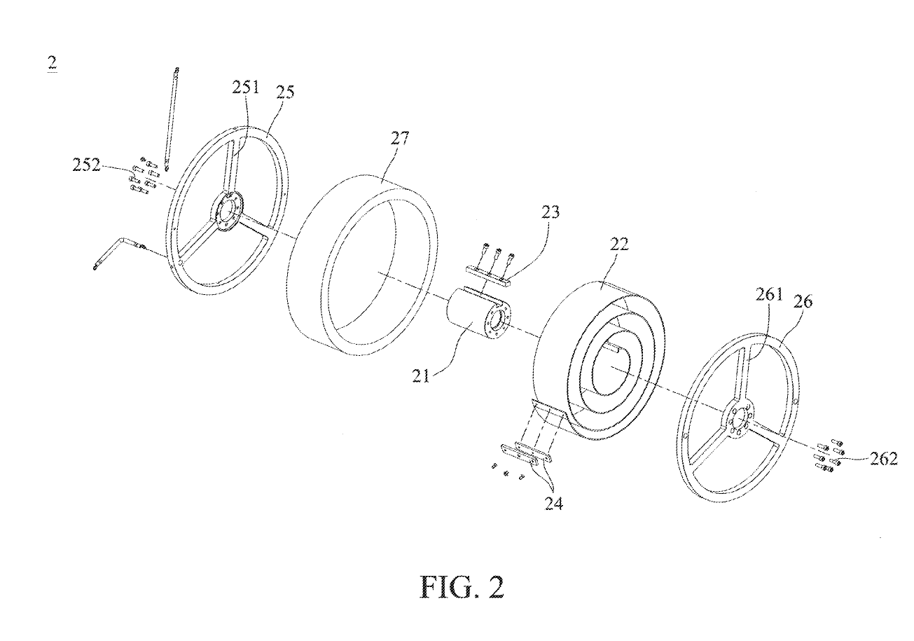

Referring to FIGS. 1 and 2, diagrams illustrating the structure of a direct heating desiccant wheel according to the present disclosure are given.

FIG. 1 is a schematic diagram illustrating a dehumidification substrate in the direct heating desiccant wheel in accordance with the present disclosure. The dehumidification substrate 1 includes: a metal substrate 11, upper and lower adhesive film layers 12 and 13, and upper and lower adsorption materials 14 and 15. When the metal substrate 11 is connected to a suitable power supply, the metal substrate 11 is heated, and the thermal energy will be conducted directly by solid heat transfer to the upper and lower adsorption materials 14 and 15, thereby allowing desorption of moisture therein and regeneration of the desiccant wheels.

FIG. 2 is an exploded view illustrating the structure of the direct heating desiccant wheel 2 in accordance with the present disclosure. The direct heating desiccant wheel 2 essentially includes: a central wheel axle 21, a direct heating adsorption substrate 22, a wavy spacer plate (not shown), an inner electrode plate 23, an outer electrode plate set 24, upper and lower wheel frames 25 and 26, and an insulating foam 27. When the direct heating adsorption substrate 22 is rolled up, the wavy spacer plate is sandwiched between adjacent substrate materials, such that a parallel channel is formed between two substrate materials. The direct heating adsorption substrate 22 is fixed at one end to the central wheel axle 21 via the inner electrode plate 23, while the other end forming an outer electrode plate with the outer electrode plate set 24 clamped thereon. When the inner electrode plate 23 and the outer electrode plate set 24 are provided with power, the direct heating adsorption substrate 22 produces heat for regeneration desorption.

Moreover, insulated industrial plastic (e.g., Teflon, PEEK, POM, or Bakelite) are provided at the top and bottom of the direct heating desiccant wheel 2 to form the upper and lower wheel frames 25 and 26 as the exterior of the desiccant wheel. The upper and lower wheel frames 25 and 26 can be fastened onto the central wheel axle via upper and lower screw sets 252 and 262, thereby positioning the direct heating adsorption substrate 22. The upper and lower wheel frames 25 and 26 are provided with a plurality of reinforcement ribs 251 and 261 to reinforce the structural strength of the wheel frames.

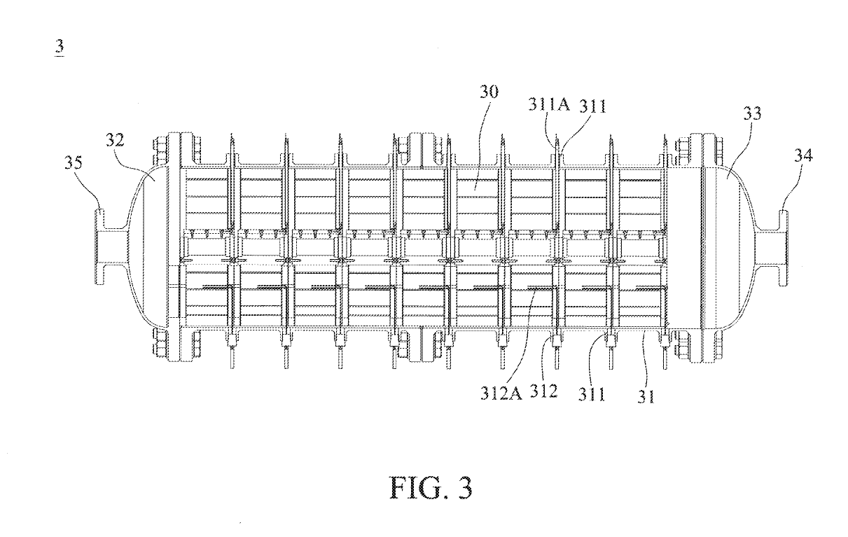

FIG. 3 is a schematic diagram illustrating the interior structure of a desiccant wheel drying device 3 made up of a plurality of desiccant wheels 30 connected in series. The desiccant wheel drying device 3 includes a plurality of desiccant wheels 30 and a pressure tank 31 for adsorption dehumidification of moisture in compressed air and desorption regeneration. The pressure tank 31 is used for receiving the desiccant wheels 30. An upper tank lid 33 and a lower tank lid 32 are joined to the top and bottom of the pressure tank 31, respectively, forming a pressurized chamber. An air inlet/outlet connection pipeline 35 is provided on the lower tank lid 32 for discharging compressed air out of the pressure tank 31 after adsorption dehumidification, and is connected to a dry compressed air transfer pipeline. In an embodiment, the air inlet/outlet connection pipeline 35 is also connected to a regeneration gas inlet pipeline for transporting air required for the regeneration process. In an embodiment, an air inlet/outlet connection pipeline 34 is provided on the upper tank lid 33 connected to a compressed air transfer pipeline containing air to be dehumidified. In an embodiment, the air inlet/outlet connection pipeline 34 is also connected to a regeneration gas inlet pipeline for discharging the hot and humid air after the regeneration process. Direct heating desiccant wheel power cable connection holes 311 and corresponding power cables 311A are provided at suitable locations of the tank. A power cable 311A is connected to the inner electrode plate 23 and the outer electrode plate set 24 of a corresponding desiccant wheel 30 in the pressure tank 31 for providing power necessary for thermal regeneration. Temperature sensor connection holes 312 are connected to corresponding thermometers 312A for sensing regeneration temperature of the corresponding desiccant wheels 30.

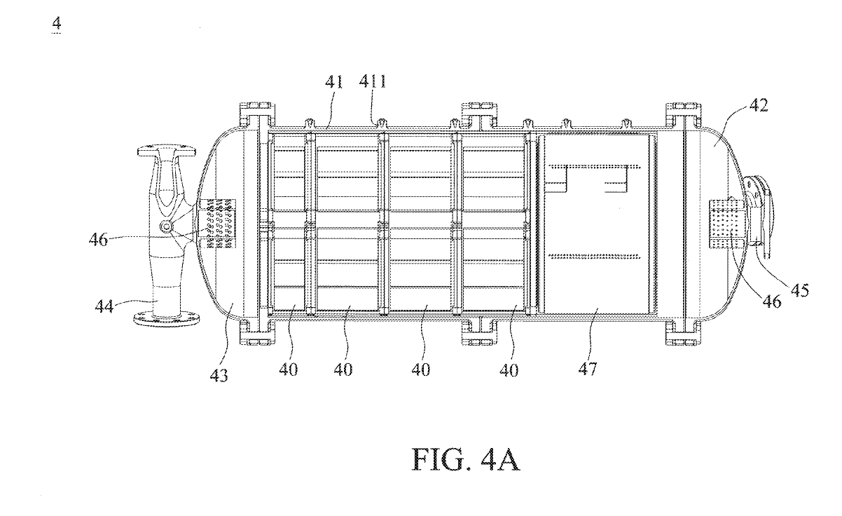

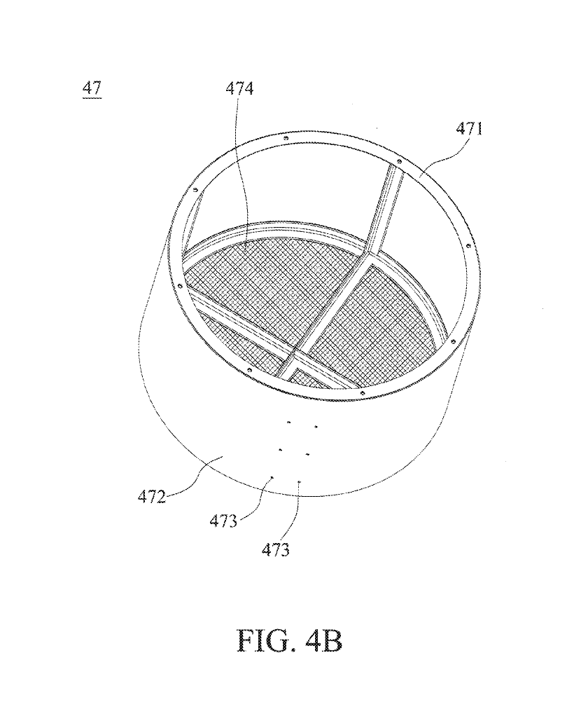

FIG. 4A is a schematic diagram illustrating the interior structure of a drying device made up of a plurality of desiccant wheels and adsorbent. The desiccant wheel drying device 4 includes a plurality of desiccant wheels 40, a particle adsorbent basin 47, and a pressure tank 41 for adsorption dehumidification of moisture in compressed air and desorption regeneration. The pressure tank 41 is used for receiving the direct heating desiccant wheels 40 and the particle adsorbent basin 47. The particle adsorbent basin 47 is provided above the direct heating desiccant wheels, so that the adsorbent particles in the particle adsorbent basin 47 may use the excess heat from the desiccant wheels 40 down below for desorption regeneration. A lower tank lid 43 and an upper tank lid 42 are joined to the pressure tank 41, forming a pressurized chamber. An inlet/outlet connection pipeline 44 is provided on the lower tank lid 43 for discharging compressed air out of the pressure tank 41 after adsorption dehumidification, and is connected to a dry compressed air transfer pipeline. In an embodiment, the inlet/outlet connection pipeline 44 is also connected to a regeneration gas inlet pipeline for transporting air required for the regeneration process. In an embodiment, an inlet/outlet connection pipeline 45 is provided on the upper tank lid 42. A diffusion net 46 is provided in each of the upper and lower tank lids 42 and 43 for evenly diffusing the air pumped into the pressure tank to increase adsorption. Direct heating desiccant wheel power cable connection holes 411 and corresponding temperature sensor connection holes are provided at suitable locations of the tank.

FIG. 4B is a schematic diagram illustrating the structure of the particle adsorbent basin in accordance with the present disclosure. The overall structure of the particle adsorbent basin 47 includes a reinforcement frame 471, a barrel plate 472 soldered as the periphery with thermometer holes 473 provided thereon to facilitate the installation of the thermometers. In an embodiment, a mesh floor plate 474 is soldered at the bottom of the barrel for carrying the adsorbent particles and allowing air flow.

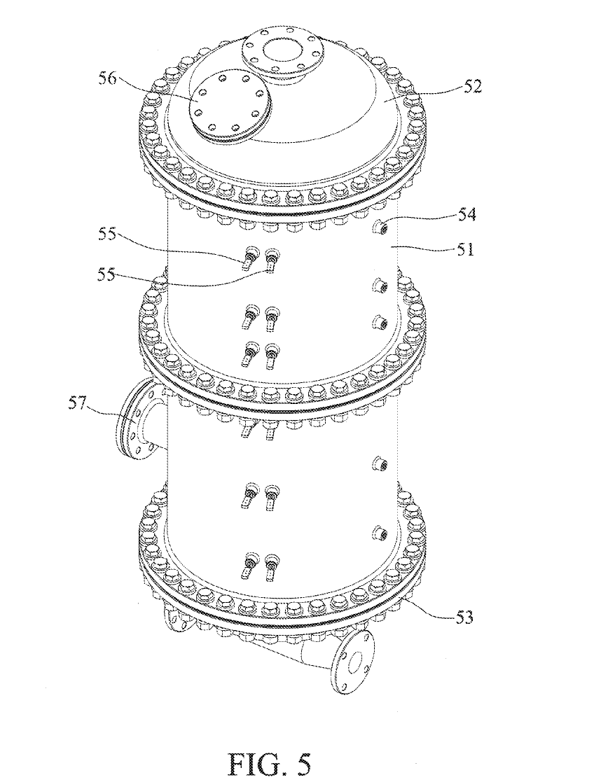

FIG. 5 is a schematic diagram illustrating the outer appearance of the desiccant wheel drying device 3 or 4 shown in FIG. 3 or 4 above. As shown, a power cable connection hole 54 is provided on the barrel of the pressure tank 51 at a location corresponding to a desiccant wheel at each level for providing power required for regeneration heating of the direct heating desiccant wheels. Similarly, on a location corresponding to the desiccant wheel at each level, a thermometer power connection hole 55 is provided for providing temperature sensing and indication during regeneration heating of the direct heating desiccant wheels. A lower tank lid 53 and an upper tank lid 52 are combined to the pressure tank 51, forming a pressurized chamber. In addition, an inlet 56 is provided on the upper tank lid 52 for filling or replacing the adsorbent inside the particle adsorbent basin. An outlet 57 is provided below the pressure tank for clearing out undesired matter inside the pressure tank 51.

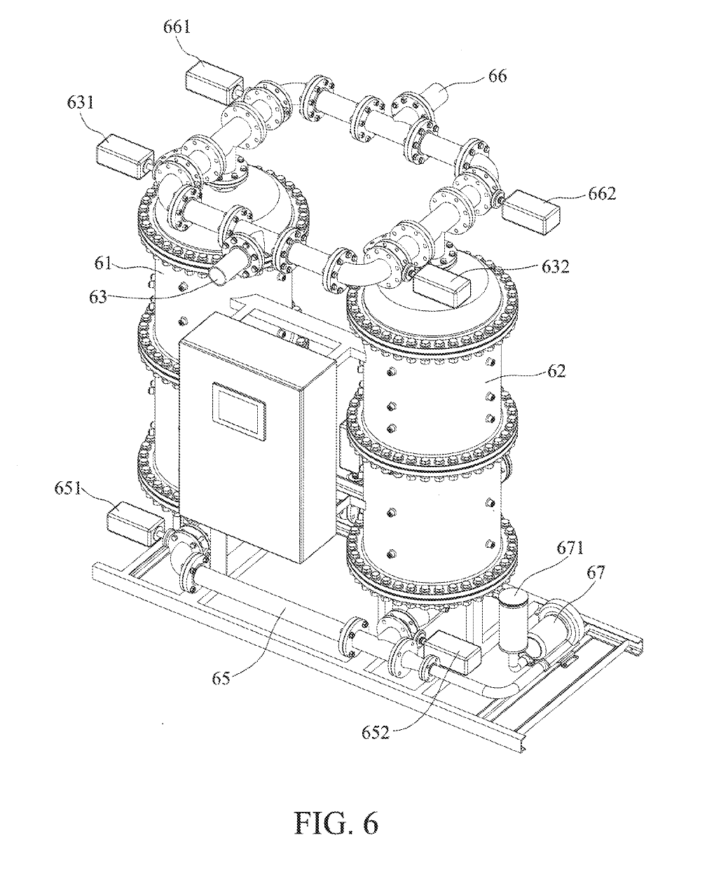

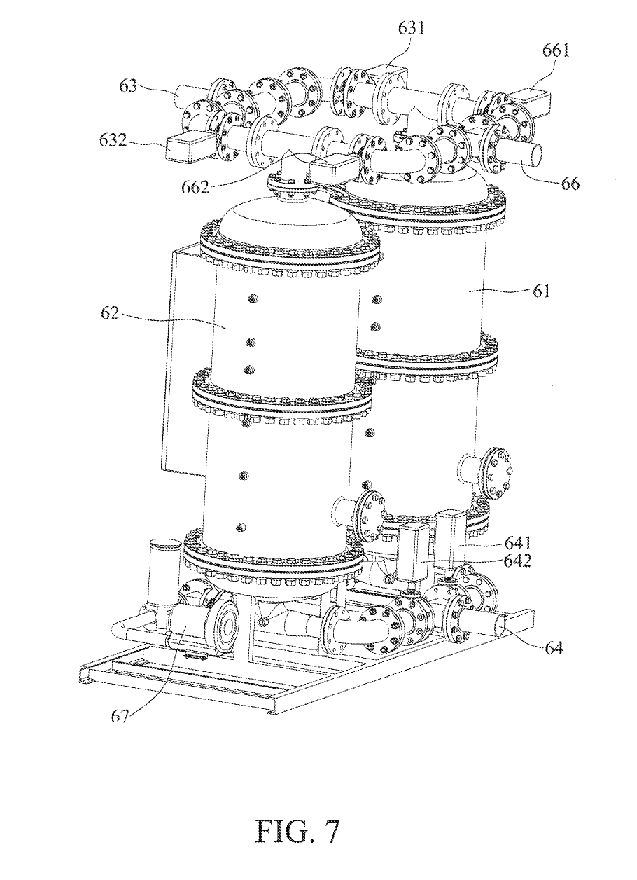

Referring to FIGS. 6 and 7, a drying apparatus using two drying devices each made up of a plurality of desiccant wheels or a drying apparatus using two drying devices each made up of a combination of a plurality of desiccant wheels and adsorbent are provided, respectively. FIG. 6 is a schematic diagram illustrating the front appearance of the compressed air drying apparatus in accordance with the present disclosure. FIG. 7 is a schematic diagram illustrating the back appearance of the compressed air drying apparatus in accordance with the present disclosure. The structure of the drying apparatus includes a plurality of pressure drying tanks (called pressure tanks 61 and 62 hereinafter), which perform adsorption desiccant and desorption regeneration, and functions are exchanged in batches through associated control valves and pipelines.

The dehumidification process of the drying apparatus is described below. A dehumidification inlet pipeline 63 is provided above each of pressure tanks 61 and 62. By turning on a dehumidification inlet valve 631 and turning off a dehumidification inlet valve 632, compressed air to be dehumidified is guided to the pressure tank 61 for moisture adsorption drying treatment. The temperature of the adsorption materials 14 and 15 (as shown in FIG. 1) in the pressure tank 61 will rise after the regeneration process. This would reduce the adsorption efficiency. A cooling device (not shown) is needed to provide cool air to cool down the adsorption materials 14 and 15. Typically, adsorption drying treatment is performed after the temperature is cooled below 50° C. Dehumidified compressed air is guided below the pressure tank 61 to an appropriate place through a dehumidification exhaust pipeline 64 by turning on a dehumidification exhaust valve 641 and turning off a dehumidification exhaust valve 642. This is the dehumidification process of the drying apparatus according to the present disclosure and its relevant structural elements.

Once the direct heating desiccant wheels and the adsorbent particles (hybrid type) or the direct heating desiccant wheels (single type) have adsorbed enough moisture, regeneration process is performed by thermal energy desorption regeneration, which essentially allows moisture to come out of the adsorbent. The desorption regeneration process of the drying apparatus is described below. A regeneration fan 67 provides the drive for air circulation during desorption regeneration. A regeneration fan filter 671 filters out dust or impurities in the air entering the fan. By turning on a regeneration inlet valve 651 and turning off a regeneration inlet valve 652, the air for regeneration is guided through a regeneration inlet pipeline 65 to the pressure tank 61. Meanwhile, the direct heating desiccant wheels in the pressure tank 61 are heated by a programmable logic controller (PLC) in an electric control box to a specific temperature depending on the types of adsorbent (adsorption materials 14 and 15). For example, 80-140° C. is for silica; and 100-170° C. is for zeolite (molecular sieve). The air after regeneration in the pressure tank 61 is exhausted through a regeneration exhaust pipeline 66 by turning on a regeneration exhaust valve 661 and turning off a regeneration exhaust valve 662.

In the example of above, if the pressure tank is composed of direct heating desiccant wheels only, nine desiccant wheels can be employed (as shown in FIG. 3); if the pressure tank is composed of hybrid materials, i.e., a combination of direct heating desiccant wheels and adsorbent particles (made of the same material as the adsorption materials 14 and 15 in FIG. 1), there can be four direct heating desiccant wheels connected in series with a particle adsorbent basin added on top. In terms of the hybrid drying apparatus, at the beginning of the regeneration, the four direct heating desiccant wheels will be heated simultaneously. When the temperature reaches the temperature required for desorption regeneration of the adsorbent, the first set of direct heating desiccant wheel will continue to be heated; while the second, third, and fourth sets will be heated intermittently to compensate for insufficient regeneration temperature until it reaches the suitable temperature. The adsorbent in the particle adsorbent basin achieves desorption regeneration using the excess heat generated during regeneration transmitted from the direct heating desiccant wheels below, thereby saving energy on the overall drying apparatus.

The dehumidification adsorption and the desorption regeneration of the pressure tank 62 are similar to those described for the pressure tank 61, except that the actuations for the control valves are opposite, details of which are not repeated.

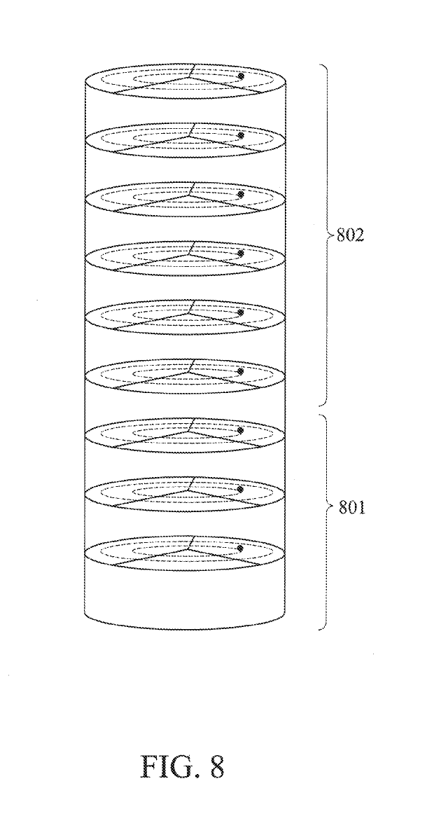

FIG. 8 is a power supply diagram for a compressed air drying apparatus containing direct heating desiccant wheels only. In an embodiment, a design of nine direct heating desiccant wheels is used, and the power supply wirings are described as follow. The regeneration heating power control of the bottom three desiccant wheels 801 is performed in an independent power distribution manner, and the power of the top six desiccant wheels 802 is controlled by in sets of three connected like the letter Y. During desorption regeneration of this system, thermal energy generated during regeneration heating of the bottom three desiccant wheels may be transmitted upwards through the regeneration air flow, such that the heating of the top six desiccant wheels may utilize the excess heat from the three desiccant wheels below. The above power supply wiring method may vary depending on the size or quantity of the desiccant wheels. It is submitted that any wiring method is within the claims according to the present disclosure as long as layered heating is performed. Therefore, a system with direct heating desiccant wheels only performing regeneration for an hour can provide −40° C. high pressure dry air of 3 CMM for 1.9 hours with 5% of cooling air consumption, so the energy consumption is approximately 0.8 kW/CMM. Compared to a conventional indirect heating high-pressure air adsorption drying apparatus with a particle-only adsorption device, the present disclosure saves energy by 11%-50%.

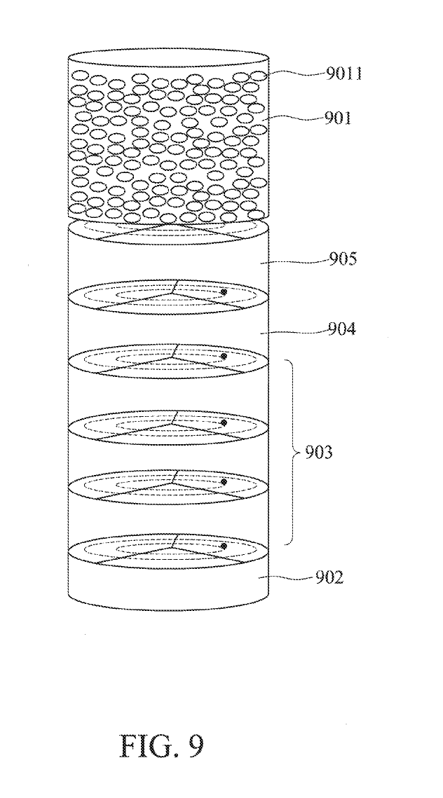

FIG. 9 is a power supply diagram for a compressed air drying apparatus with hybrid adsorption components. In this embodiment, the design of nine direct heating desiccant wheels shown in FIG. 8 can be used, but the top three desiccant wheels are replaced by a particle adsorbent basin 901. The particle adsorbent basin 901 is filled with adsorbent particles 9011. The advantage is that the adsorbent capacity of the overall system is increased, thus increasing the adsorption capacity. Moreover, since this system reduces the number of direct heating desiccant wheels by three, the installation cost is reduced. Furthermore, when desorption regeneration is carried out, the adsorbent particles on the top of the system works on just the excess heat from the six direct heating desiccant wheels below, thereby achieving energy saving for the desorption regeneration process.

In terms of power supply distribution, the six direct heating desiccant wheels are divided into four groups from bottom to top, wherein the 1^{st} wheel 902 is independently supplied with power. The 2^{nd}, 3^{rd}, and 4^{th} wheels 903 are connected in a Y-shaped arrangement for power supply distribution. The 5^{th} and 6^{th} wheels 904 and 905 are also independently supplied with power. The above power supply wiring method may vary depending on the size or quantity of the desiccant wheels and the weight of the adsorbent particles. It is submitted that any wiring method is within the claims according to the present disclosure as long as layered heating is performed. The temperatures of the four sets of direct heating desiccant wheels are individually controlled based on system requirements using feedbacks from the corresponding thermometers. Experimental results show that, compared with the system containing nine direct heating desiccant wheels, at high pressure air inlet dew point −8° C.˜−10° C., the hybrid adsorption drying system was able to maintain outlet dew point below −30° C. for 2.8 hours. Similarly, based on 5% air consumption, the overall energy consumption indicator is about 0.7 kW/CMM. Compared to the roughly 0.8 kW/CMM of energy consumed by the system with nine direct heating desiccant wheels, this is about 12.5% saving on energy. In terms of adsorption time, as the desiccant wheels were replaced by adsorbent particles in the hybrid system, the adsorption dehumidification time was 2.8 hours, which is a 40% increase than the 2 hours it took for the nine-wheel system. As the number of direct heating desiccant wheels is reduced by three in the hybrid system, the installation cost of the direct heating desiccant wheels is 30% cheaper than the nine-wheel system. The various comparison results are shown in Table 1 below.

TABLE 1
Comparison of direct heating only and hybrid compressed air drying
apparatuses

| | | Energy | | |
|---|---|---|---|---|
| | Adsorption | Consumption | Energy Consumption | Cost |
| | Time (hr) | (kW) | Indicator (kW/CMM) | (TWD) |
| Direct | 2 | 2.3 | 0.8 | 448,000 |
| Only | | | | |
| Hybrid | 2.8 | 3.3 | 0.7 | 313,668 |

Compared to the prior art, the drying device made up of desiccant wheels only or a combination of desiccant wheels and adsorbent and the drying apparatus using the same achieve equalized temperatures of the air passages for the dehumidification components during the desorption regeneration process through preheating by a preheater and electrically-controlled layered heating, thereby reducing energy consumption and improving efficiency of the desorption regeneration process.

The above embodiments are only used to illustrate the principles of the present disclosure, and should not be construed as to limit the present disclosure in any way. The above embodiments can be modified by those with ordinary skill in the art without departing from the scope of the present disclosure as defined in the following appended claims.

What is claimed is:

1. A desiccant wheel drying device, comprising:
a plurality of desiccant wheels;
a pressure tank for receiving the plurality of desiccant wheels; and
an upper tank lid and a lower tank lid joined to the top and the bottom of the pressure tank, respectively, to form a pressurized chamber.

2. The desiccant wheel drying device of claim 1, wherein the plurality of desiccant wheels are direct heating desiccant wheels connected in series in the pressure tank.

3. The desiccant wheel drying device of claim 1, further comprising a particle adsorbent basin connected in series on the top of the plurality of desiccant wheels.

4. The desiccant wheel drying device of claim 3, wherein the particle adsorbent basin includes a particle adsorbent.

5. The desiccant wheel drying device of claim 3, further comprising a barrel plate soldered at a periphery of the particle adsorbent basin and provided with a thermometer hole for installation of a thermometer, and a mesh floor plate soldered at a bottom of the barrel plate for carrying adsorbent particles and allowing air circulation in the particle adsorbent basin.

6. The desiccant wheel drying device of claim 4, further comprising an inlet provided on the upper tank lid and for filling or replacing the particle adsorbent in the particle adsorbent basin, and an outlet provided below the pressure tank and for clearing out undesired matter in the pressure tank.

7. The desiccant wheel drying device of claim 1, further comprising a first inlet/outlet connection pipeline provided on the lower tank lid and connected to a dehumidified compressed air transport pipeline, wherein the plurality of desiccant wheels are supplied with power independently or in groups.

8. The desiccant wheel drying device of claim 1, further comprising a second inlet/outlet connection pipeline provided on the upper tank lid and connected to a compressed-air-to-be-dehumidified transport pipeline.

9. The desiccant wheel drying device of claim 1, further comprising direct heating desiccant wheel power cable connection holes and corresponding temperature sensor connection holes provided on the pressure tank.

10. The desiccant wheel drying device of claim 1, wherein each of the plurality of desiccant wheels further includes a metal substrate, upper and lower adhesive film layers, and upper and lower adsorption materials, and wherein when power is supplied to the metal substrate, the metal substrate heats up and provides thermal energy to be directly conducted to the upper and lower adsorption materials to desorb moisture contained in the upper and lower adsorption materials and achieve regeneration of each of the plurality of desiccant wheels.

11. The desiccant wheel drying device of claim 1, further comprising a diffusion net provided on each of the upper and lower tank lids and for evenly diffusing air transported into the pressure tank to increase adsorption.

12. A drying apparatus comprising:
two drying devices each composed of a plurality of desiccant wheels;
a dehumidification inlet pipeline connected to the two drying devices for guiding compressed air to be dehumidified;
a dehumidification exhaust pipeline connected to the two drying devices for guiding the compressed air after dehumidification;
a regeneration inlet pipeline for providing air for regeneration;
a regeneration exhaust pipeline for discharging the air for regeneration; and
control valves for turning on or turning off the dehumidification inlet pipeline, the dehumidification exhaust pipeline, the regeneration inlet pipeline and the regeneration exhaust pipeline, and for controlling the heating of the plurality of desiccant wheels of the two drying devices to perform a desorption process.

13. The drying apparatus of claim 12, wherein the two drying devices further comprises:
a pressure tank for receiving the plurality of desiccant wheels; and
an upper tank lid and a lower tank lid joined to the top and the bottom of the pressure tank, respectively, to form a pressurized chamber.

14. The drying apparatus of claim 13, further comprising an inlet provided on the upper tank lid and for filling or replacing an adsorbent in a particle adsorbent basin, and an outlet provided below the pressure tank and for clearing out undesired matter in the pressure tank.

15. The drying apparatus of claim 12, wherein the plurality of desiccant wheels include nine direct heating desiccant wheels, and wherein the bottom three desiccant wheels are supplied with power independently for heating of regeneration, the top six desiccant wheels are grouped into two groups with three in each group, the top six desiccant wheels in each group are connected to the power in a Y-shaped arrangement for controlling heating of regeneration, and the top six desiccant wheels utilize excess heat generated from the bottom three desiccant wheels for carrying out desorption of regeneration.

16. The drying apparatus of claim 12, wherein each of the plurality of desiccant wheels further includes a metal substrate, upper and lower adhesive film layers, and upper and lower adsorption materials, and wherein when power is supplied to the metal substrate, the metal substrate heats up and provides thermal energy to be directly conducted to the upper and lower adsorption materials to desorb moisture contained in the upper and lower adsorption materials and achieve regeneration of each of the plurality of desiccant wheels.

17. The drying apparatus of claim 13, further comprising a diffusion net provided on each of the upper and lower tank lids and for evenly diffusing air transported into the pressure tank to increase adsorption.

18. The drying apparatus of claim 12, further comprising a cooling device for cooing the air to speed up the cooling of an adsorbent in the plurality of desiccant wheels or a particle adsorbent basin, wherein the adsorbent is cooled below 50° C. before adsorption dehumidification treatment of moisture.

19. A drying apparatus comprising:
two drying devices each composed of a combination of a plurality of desiccant wheels and an adsorbent basin;
a dehumidification inlet pipeline connected to the two drying devices for guiding compressed air to be dehumidified;
a dehumidification exhaust pipeline connected to the two drying devices for guiding the compressed air after dehumidification;
a regeneration inlet pipeline for providing air for regeneration;
a regeneration exhaust pipeline for discharging the air for regeneration; and
control valves for turning on or turning off the dehumidification inlet pipeline, the dehumidification exhaust pipeline, the regeneration inlet pipeline and the regeneration exhaust pipeline, and for controlling the heating of the plurality of desiccant wheels and an adsorbent of the two drying devices to perform a desorption process.

20. The drying apparatus of claim 19, wherein the two drying devices further comprise:
a pressure tank for receiving the plurality of desiccant wheels and the adsorbent basin; and
an upper tank lid and a lower tank lid joined to the top and the bottom of the pressure tank, respectively, to form a pressurized chamber.

21. The drying apparatus of claim 19, wherein the adsorbent basin containing adsorbent particles is provided in series on the top of the plurality of desiccant wheels.

22. The drying apparatus of claim 21, further comprising a barrel plate soldered at a periphery of the adsorbent basin and provided with a thermometer hole for installation of a thermometer, and a mesh floor plate soldered at a bottom of the barrel plate and for carrying the adsorbent particles and allowing air circulation in the adsorbent basin.

23. The drying apparatus of claim 19, wherein each of the plurality of desiccant wheels further includes a metal substrate, upper and lower adhesive film layers, and upper and lower adsorption materials, and when power is supplied to the metal substrate, the metal substrate heats up and provides thermal energy to be directly conducted to the upper and lower adsorption materials to desorb moisture contained in the upper and lower adsorption materials and achieve regeneration of each of the plurality of desiccant wheels.

24. The drying apparatus of claim 20, further comprising a diffusion net provided on each of the upper and lower tank lids and for evenly diffusing air transported into the pressure tank to increase adsorption.

25. The drying apparatus of claim 19, wherein the adsorbent basin is connected in series with the plurality of desiccant wheels composed of six direct heating desiccant wheels, and the six direct heating desiccant wheels are supplied with power in four groups from bottom to top, and wherein the adsorbent basin is independently supplied with power, the first desiccant wheel is independently supplied with power, the second to the fourth desiccant wheels are supplied with power in a Y-shaped arrangement, and the fifth and the sixth desiccant wheels are independently supplied with power.

26. The drying apparatus of claim 19, further comprising a cooling device for cooing the air to speed up the cooling of the adsorbent in the plurality of desiccant wheels or the adsorbent basin, wherein the adsorbent is cooled below 50° C. before adsorption dehumidification treatment of moisture.
